(19) United States
(12) Patent Application Publication
(10) Pub. No.: US 2003/0159592 A1
(43) Pub. Date: Aug. 28, 2003

(54) Table mountable fryer

(76) Inventors: Ryoichi Saito, Yamatoshi (JP); Kazuyuki Ito, Yamatoshi (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/364,396

(22) Filed: Feb. 12, 2003

(30) Foreign Application Priority Data
Feb. 27, 2002 (JP) 2002-000958 U

(51) Int. Cl. A23L 1/00; A47J 37/12

(52) U.S. Cl. 99/330; 99/403

(57) ABSTRACT

In a table mountable fryer according to the present invention, a frying vessel which contains water and oil in a state where an oil layer is formed on a water layer due to a difference in their specific gravities is installed at the center of a table. The fryer comprises a heater installed in the frying vessel for heating the oil layer, a water level sensor installed at a predetermined position below the heater in the frying vessel for detecting an interface between the water and oil layers, and an oil layer heating control means connected to the water level sensor for stopping heating the oil layer by the heater in response to the detection of the interface by the water level sensor.

Therefore, a general user other than a cook can take a meal and drink beverages while safely and freely cooking fries at table by installing the frying vessel, which has the oil layer and the water layer therein at the upper and lower portions, respectively, at the center of the table. Oxidization of the oil layer can be prohibited and deterioration of the oil layer or generation of oil fumes due to fry remnants or burned remnants can be prevented. Moreover, even the general user who does not know discharge timing of the water depending on the amount of cooked fries can easily and safely utilize the fryer.

### BACKGROUND OF THE INVENTION

1. Field of Invention

The present invention generally relates to a table mountable fryer by which a general user can take a meal while cooking fries safely and freely at table. Particularly, the present invention relates to a table mountable fryer capable of allowing a general user himself to enjoy directly cooking fries such as grilled meat and vegetables on skewers and to eat them. More particularly, the present invention relates to a table mountable fryer of which a frying vessel is installed at the center of a table, contains water and oil in a state where an oil layer is formed on a water layer due to a difference in their specific gravities, has a heater for heating the oil layer and a cooling pipe installed below the heater for cooling a portion of the oil layer below the heater, and is constructed such that fry remnants are deposited in the lower water layer.

2. Description of the Prior Art

A fryer in which a lower water layer and an upper oil layer are formed due to a difference of their specific gravities as described above and fries are cooked by heating the oil layer is disclosed, for example, in Japanese Patent Laid-Open Publication No. 55-40249. In such a conventional kind of fryer, water and oil are contained in a frying vessel and an interface between water and oil layers is positioned slightly below a cooling pipe. Thus, a portion of the oil layer in the middle of the frying vessel is heated by means of a heater and a portion of the oil layer below the heater is simultaneously cooled by causing external air as a cooling fluid to pass through the cooling pipe. Accordingly, oxidization of the oil layer due to increase in temperature of the entire oil layer is prohibited and increase in temperature of the water layer in the middle of the frying vessel is prevented. Therefore, fry remnants sunk from the heated oil layer are sunk into the water layer and thus prevented from floating into the oil layer. As a result, deterioration of the oil layer due to the fry remnants or generation of fumes from the oil due to burning of the fry remnants is prevented. Consequently, it is not necessary to filter the oil and it is possible to reduce the amount of waste oil as a replacement period of the oil is prolonged.

Such a conventional fryer has been developed as a commercial fryer on the assumption that it will be handled by a professional cook. Therefore, the conventional fryer is generally not suitable for general user's own cooking of fries, for example, like a griller. For instance, if a child or adult erroneously spills a drink and thus the drink is mixed with the water in the frying vessel, there may be a case where the water rapidly boils. Further, in a case where the general user utilizes the fryer, it is pursued to reduce a working burden on removal of deposited fry remnants or on cleaning thereof. Particularly, in a case where it is assumed that the general user utilizes the fryer in a restaurant and the like, it is pursued to reduce the working burden.

### SUMMARY OF THE INVENTION

The present invention is conceived to solve the problems. An object of the present invention is to provide a table mountable fryer constructed such that a general user can utilize the fryer in a store by installing the fryer, which has a frying vessel within which an oil layer is formed at an upper portion thereof and a water layer is formed beneath the oil layer, on a table so that a drink which may flow into the frying vessel can directly fall into the lower water layer due to a difference in specific gravities of the water and oil and thus explosive generation of water vapor can be prevented. Another object of the present invention is to provide a table mountable fryer capable of being used as a griller. If conventional fryers are attached to several tens of tables in a meat grill restaurant, it takes much time and efforts to remove fry remnants adhering to the bottom of frying vessels of the fryers and thus they are not suitable for use in the restaurant. Therefore, a further object of the present invention is to provide a table mountable fryer capable of reducing a burden on cleaning works since the table mountable fryer with a frying vessel which is installed at the center of a table and contains oil and water at upper and lower portions thereof, respectively, is utilized and thus fry remnants do not adhere thereto owing to the presence of the water at the lower portion.

In order to achieve these objects of the present invention, the present invention provides a table mountable fryer, wherein a frying vessel of the table mountable fryer is installed at the center of a table and contains oil and water at upper and lower portions thereof, respectively, and heating of the oil is controlled by detecting a position of an interface between the oil and the water. Accordingly, even a general user can safely cook fries by himself/herself.

The table mountable fryer of the present invention comprises a frying vessel which contains water and oil in a state where an oil layer is formed on a water layer due to a difference in their specific gravities; a heater installed in the middle of the frying vessel for heating the oil layer; a cooling pipe installed below the heater for cooling a portion of the oil layer below the heater; a first water level sensor installed at a predetermined position below the heater for detecting an interface between the water and oil layers; and an oil layer heating control means for stopping heating the oil layer by the heater in response to the detection of the interface by the first water level sensor.

According to the table mountable fryer of the present invention constructed as such, contrary to the conventional fryer described above, oxidization of the oil layer due to increase in temperature of the entire oil layer is prohibited by cooling the portion of the oil layer below the heater by means of the cooling pipe, and increase in temperature of the water layer in the middle of the frying vessel is prevented. Therefore, fry remnants sunk from the heated oil layer are sunk into the water layer and thus prevented from floating into the oil layer. As a result, deterioration of the oil layer due to the fry remnants or generation of fumes from the oil due to burning of the fry remnants is prevented. On the other hand, in the table mountable fryer of the present invention described above, if the first water level sensor detects that the interface between the water and oil layers reach a predetermined position below the heater in the middle of the frying vessel as the interface is raised due to increase of the amount of fry remnants which result from increase of cooked fries and then are sunk into the water layer, the oil layer heating control means to which the output of the first water level sensor is input stops heating the oil layer by the heater.

Therefore, even a person who does not know discharge timing of the water depending on the amount of cooked fries can securely avoid a risk that water vapor may be generated in the water layer and thus the heated oil may be splashed. Accordingly, the person can easily and safely utilize the fryer. Further, since a warning issued from the output of the first water level sensor is shown as lighting of a red lamp, and the like, a general user or service worker can be notified of the discharge timing of the water.

Preferably, the table mountable fryer of the present invention constructed as such further comprises a second water level sensor for detecting the interface at a predetermined position below the first water level sensor disposed at a relatively upper portion in the middle of the frying vessel. The oil layer heating control means preferably starts again heating the oil layer by the heater upon detection of the interface by the second water level sensor after the detection of the interface by the first water level sensor.

With such constitution, it is possible to securely avoid the risk that the water vapor may be generated at the interface and thus the heated oil may be splashed. After the first water level sensor detects that the interface reaches the predetermined position below the heater in the middle of the frying vessel, and the oil layer heating control means stops heating the oil layer by the heater, the user performs, for example, the discharge of the water through a water discharge valve installed at a lower end of the frying vessel as well as removal of the fry remnants so as to eliminate a risk of overheating of the water layer. Then, when the second water level sensor detects lowering of the interface, the oil layer heating control means starts again heating the oil layer by the heater. Therefore, even though the user does not know a method of using the fryer, it is possible to keep a period of time for stopping the heating of the oil layer as short as possible. Moreover, it is possible to keep time required for heating again the oil layer as short as possible. Finally, the fryer of the present invention can improve the use or thermal efficiency thereof.

Preferably, in the table mountable fryer of the present invention constructed as such, the oil layer heating control means comprises a warning means for issuing a warning when the water level sensors detect the interface. For example, the warning means may be an audible warning means using a sound such as a buzzer or bell, a visual warning means using light such as a lamp, or a composite warning means using both the sound and light.

With such Constitution, it is possible to securely avoid the risk that the water vapor may be generated due to heating of the water resulting from the raise of the interface and thus the heated oil may be splashed. The user can directly know that the oil layer heating control means stops heating the oil layer by the heater when the second water level sensor detects that the interface has reached the predetermined position below the heater in the middle of the frying vessel. Therefore, it is possible to reduce time required until the user performs, for example, the discharge of the water through the water discharge valve installed at the lower end of the frying vessel as well as the removal of the fry remnants so as to eliminate such a risk and the heating of the oil layer by the heater is started again. Accordingly, it is also possible to keep the period of time for stopping the heating of the oil layer as short as possible. Moreover, it is possible to keep the time required for heating again the oil layer as short as possible. Finally, the fryer of the present invention can improve the use or thermal efficiency thereof.

Preferably, the oil layer heating control means further comprises an additional warning means for issuing a warning when the second water level sensor detects the interface. Therefore, it is possible to detect that the water level is exceedingly lowered, so as to effectively prevent the user from performing excessive discharge of the water.

In order to enhance the performance of the cooling pipe or heater, the cooling pipe or heater may take the shape of a circle or ellipse in cross section.

The frying vessel is V-shaped in cross section at the lower portion thereof and constructed such that one lateral side of the lower portion of the frying vessel is inclined downward and the water discharge valve is installed at an end of the lateral side. Thus, the water level can be lowered through the discharge of the water, and the fry remnants deposited on the bottom of the frying vessel can be easily removed. Furthermore, the frying vessel can be easily cleaned.

### BRIEF DESCRIPTION OF THE DRAWINGS

The above and other objects and features of the present invention will become apparent from the following description of a preferred embodiment given in conjunction with the accompanying drawings, in which:

FIG. 1 is a schematic view showing an external appearance and inner configuration of a table mountable fryer according to an embodiment of the present invention;

FIG. 2 is an exploded perspective view schematically showing major parts to be assembled in the table mountable fryer according to the embodiment of the present invention shown in FIG. 1;

FIG. 3 is a side view of the table mountable fryer when viewed from an operation panel of the fryer shown in FIG. 1;

FIG. 4 is a schematic view showing a configuration and major parts of a frying vessel of the table mountable fryer according to the embodiment of the present invention shown in FIG. l; and

FIG. 5 is a circuit diagram of a control circuit as a means for controlling a heater, water level sensors, a temperature sensor, and an overheating prevention sensor in the frying vessel of the table mountable fryer according to the embodiment of the present invention shown in FIG. 1.

### DETAILED DESCRIPTION OF THE PREFERRED EMBODIMENTS

Hereinafter, a preferred embodiment of the present invention will be described in detail with reference to the accompanying drawings.

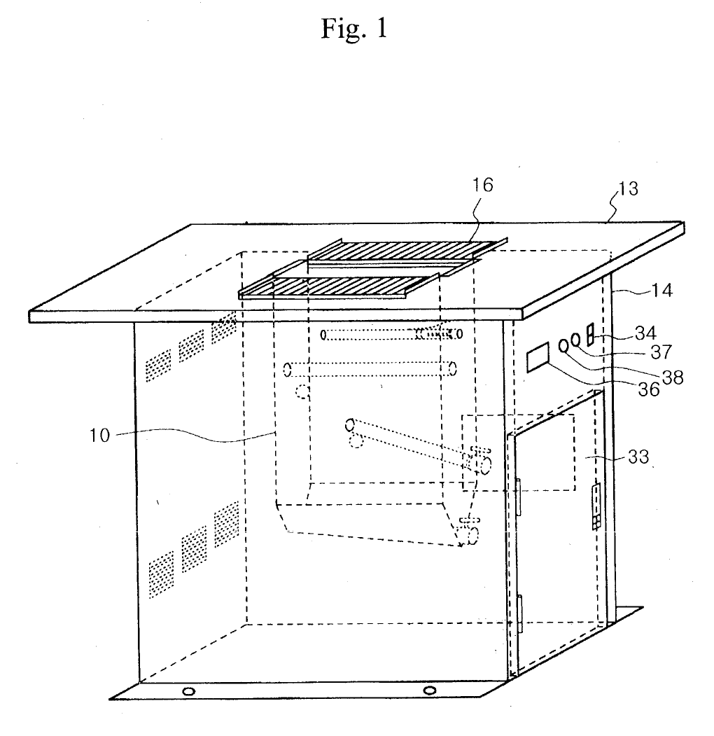

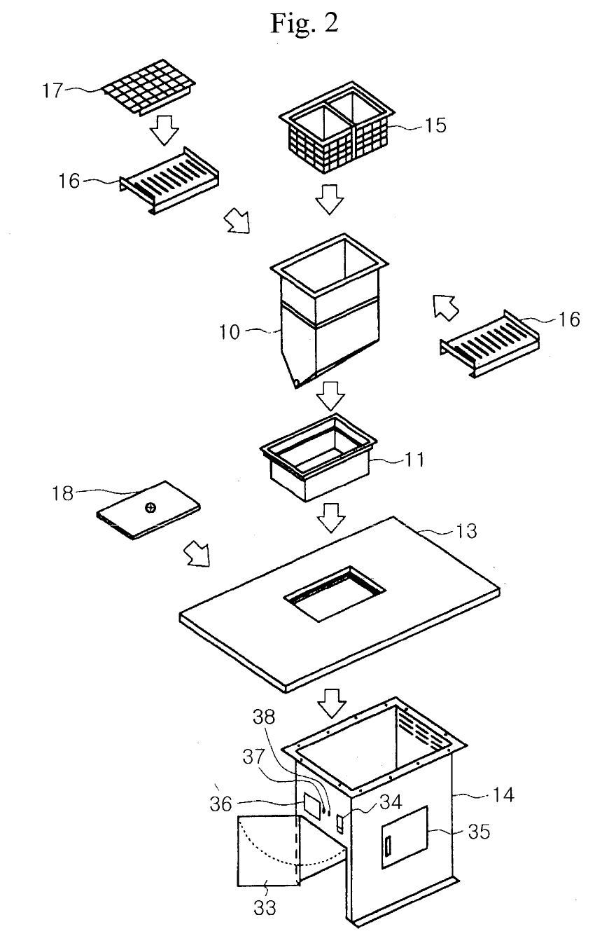

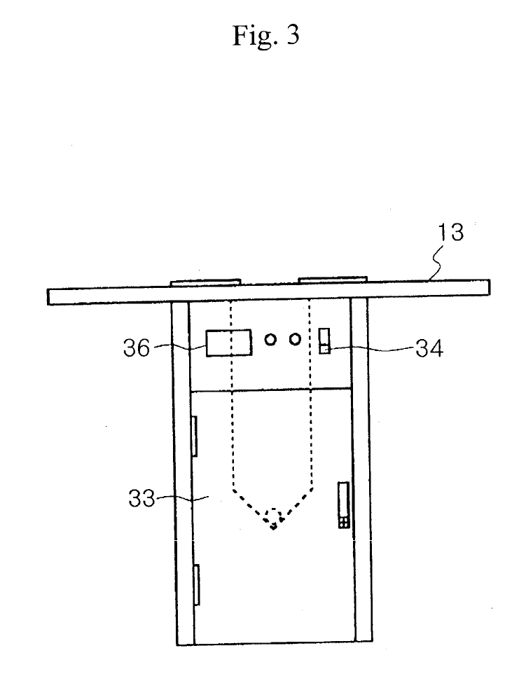

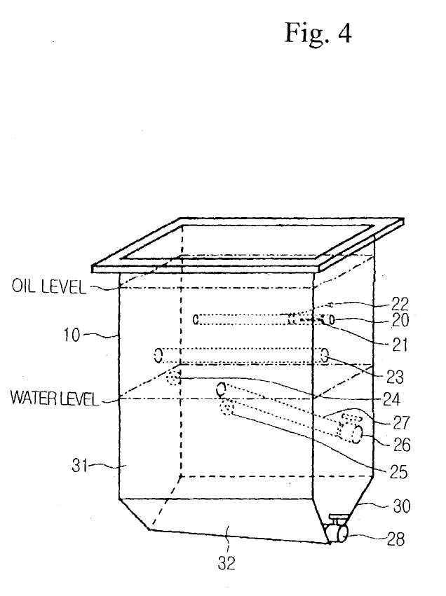

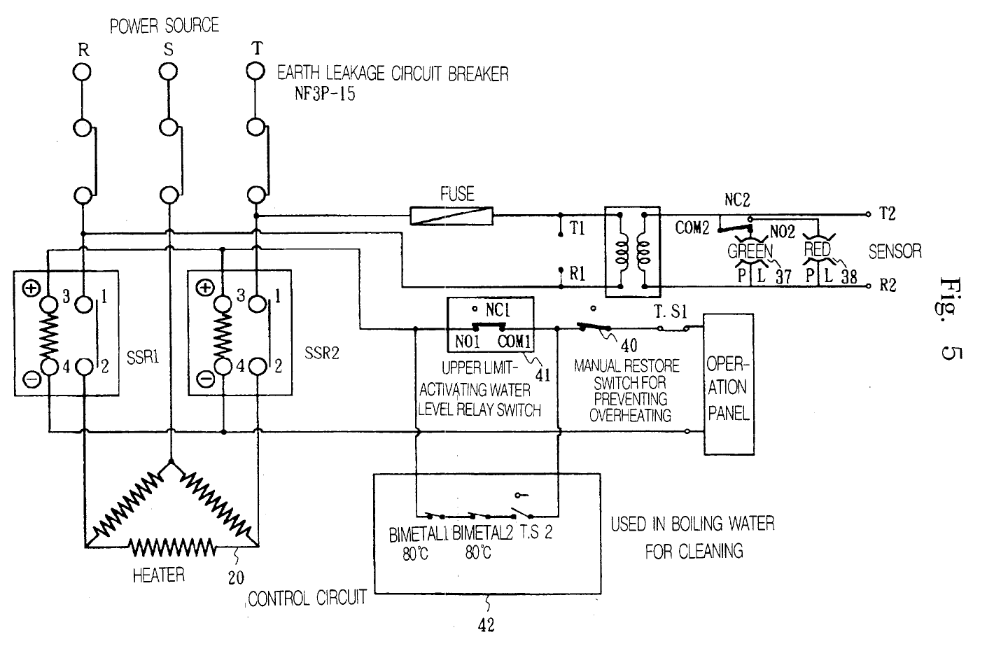

Referring to FIGS. 1 to 5, a configuration of a table mountable fryer according to the embodiment of the present invention will be explained in detail. FIG. l is a view showing inner and outer configurations of the table mountable fryer according to the embodiment of the present invention. FIG. 2 is an exploded perspective view showing major parts to be assembled in the table mountable fryer according to the embodiment of the present invention. FIG. 3 is a right side view of the table mountable fryer shown in FIG. 1. FIG. 4 is a schematic view of a frying vessel of the table mountable fryer according to the embodiment of the present invention. FIG. 5 is a diagram showing a configuration of an electrical circuit for performing heating control of an oil layer and electrical control in the table mountable fryer according to the embodiment of the present invention.

As shown in FIGS. 1 to 3, the table mountable fryer according to the embodiment of the present invention comprises a frying vessel 10 of which the top is open. The frying vessel 10 is supported by a clean plate 11 shown in FIG. 2 and mounted at the center of an upper plate 13 of a table. The upper plate 13 is put on a casing 14 of the fryer to constitute the table mountable fryer. On an upper portion of a side surface of the casing 14 are installed a power switch 34, a control box 35, an operation panel 36, a normal water level lamp 37 and a water level warning lamp 38. An openable door 33 is provided at a lower portion of the side surface of the casing where the operation panel and the like are installed.

A fry basket 15 is inserted into the frying vessel 10 put at the center of the upper plate 13. Oil catch plates 16 are put on both sides of the open top of the frying vessel 10 on the upper plate 13. Oil catch nets 17 may be put on the oil catch plates 16. Further, the portion of the upper plate 13 into which the frying vessel 10 will be inserted may be covered with a closure 18.

FIG. 4 shows a configuration of the frying vessel 10. As shown in FIG. 4, a heater 20 is installed in a substantially horizontal state to extend from a front plate 30 of the frying vessel to a rear plate 31 thereof slightly above a longitudinal middle portion of the frying vessel 10. At the same time, a cooling pipe 23 is installed in a substantially horizontal state to penetrate through an oil layer and extend from the front plate 30 to the rear plate 31 slightly below the longitudinal middle portion of the frying vessel 10. The numbers of heaters and cooling pipes may be freely determined depending on, for example, the capacity of the frying vessel, i.e. the amount of frying oil to be used, and the use temperature of the frying oil. However, the single heater 20 and the single cooling pipe 23 are employed in this embodiment, as shown in FIG. 4. Further, although cross-sectional shapes of the heater 20 and the cooling pipe 23 may be freely determined, the heater 20 is circular and the cooling pipe 23 is also circular in cross section in this embodiment, as clearly shown in FIG. 4. A refrigerant flows in the cooling pipe 23 to cool a lower portion of the oil layer. The refrigerant may be external air or the other fluids.

The predetermined amounts of frying oil and water are contained in the frying vessel 10, and a water layer is formed at a lower portion of the frying vessel 10 and an oil layer is formed on the water layer due to a difference in specific gravities of the oil and the water. The predetermined amounts of oil and water contained in the frying vessel 10 in this embodiment are determined such that an interface between the oil and the water is positioned at a predetermined level below the cooling pipe 23.

A bottom plate 32 of the frying vessel is V-shaped and inclined downward to the front plate 30, as shown in FIG. 4. A water discharge valve 28 is connected to a lower end of the front plate 30 of the frying vessel 10. An oil discharge tube 27 extends from the approximately same level as the cooling pipe 23 to an oil discharge valve 26 in the front plate 30 and is then connected to the oil discharge valve 26.

In the front plate 30 of the frying vessel 10, an upper water level sensor 24 as a first water level sensor is installed at a predetermined position below the heater 20, for example, at the approximately same level as a lower end of the cooling pipe 23 in this embodiment. A lower water level sensor 25 as a second water level sensor is installed at a predetermined position below the upper water level sensor 24, for example, at the approximately same level as the predetermined level of the interface between the oil and water layers in this embodiment.

Further, in the front plate 30 of the frying vessel 10, an overheating prevention sensor 22 is installed at a predetermined position above the heater 20, for example, at a portion above the oil layer in the frying vessel where most fries are cooked in this embodiment. Furthermore, an oil temperature sensor 21 is installed at the approximately same position as the heater 20.

As shown in FIGS. 1 to 3, an operation unit for operating the table mountable fryer of the present invention is installed at an upper portion of a front plate of the casing 14. On the operation unit are installed the operation panel 36, the warning lamps 37, 38 as warning means using lamps, the power switch 34 and the like. The operation panel 36 is to perform operations and setting so that the temperature at the upper portion of the oil layer in the frying vessel where most fries are cooked can be set to a desired temperature. A variety of electrical control equipment and electrical parts are accommodated in an electrical control box 35 within the casing 14.

Hereinafter, the operation of the table mountable fryer according to the embodiment of the present invention shown in FIGS. 1 to 4 will be explained in detail with reference to FIG. 5 that schematically shows an electrical circuit as an oil layer heating control means for controlling heating of the oil layer.

In a case where the fries are cooked using the fryer shown in FIGS. 1 to 4, the predetermined amounts of frying oil and water are first put into the frying vessel. The operation panel 36 sets the temperature sensor 21 to the desired temperature, and the power switch 34 is turned on. At this time, the interface between the oil and water layers in the frying vessel 10 is positioned at a predetermined level shown in FIG. 1. Then, the lower water level sensor 25 as the second water level sensor detects the interface. It is determined whether the upper and lower water level sensors 24, 25 in the electrical circuit are normal. If so, the normal operation of the fryer is indicated, for example, the green lamp 37 is lighted. In this embodiment, a manual restore switch 40 for preventing overheating is incorporated into the electrical circuit of FIG. 5 to prevent the overheating of the oil layer. In this embodiment, an activating temperature of the manual restore switch 40 is set to 250° C., and the supply of electrical power is shut off upon activation of the manual restore switch 40.

The cooling pipe 23 suppresses increase in the temperature of oil around the cooling pipe 23 in the oil layer as well as increase in the temperature of the water layer below the oil layer. As a result, it is possible to effectively prevent a risk that water vapor may be generated at the interface between the oil and water layers and thus the oil in the oil layer may be splashed to the outside through the open top of the frying vessel. The oil around the cooling pipe 23 suppresses the temperature of the entire oil layer as a whole. Thus, oxidization of the oil layer is reduced. Further, as for the oil layer, fry remnants or burned remnants generated from the fries cooked at a portion of the oil layer above the heater are sunk into the water layer so as to reduce deterioration of the oil layer and generation of oil fumes due to the burned remnants. Moreover, since the oil layer can be used for a long time and cleaning of the fry remnants or burned remnants is not required, fries can be efficiently cooked and deterioration of the fry cooking environment can be prevented.

If the interface between the oil and water layers is raised and approaches the heater 20 due to increase of the amount of fry remnants or burned remnants sunk into the water layer as the amount of cooked fries is increased, the upper water level sensor 24 detects the interface that has been raised up to the approximately same level as the lower end of the cooling pipe 23. Then, an upper limit-activating water level relay switch 41 interlocked with the upper water level sensor 24 is switched from a normal position NO1 to an abnormal position NC1. If the upper limit-activating water level relay switch 41 is switched to the abnormal position NC1, the green, normal water level lamp 37 is turned off. Then, the red, water level warning lamp 38 is lighted in order to warn an abnormal operation of the fryer, and supply of the electrical power to the heater 20 is shut off.

If the red, water level warning lamp 38 is lighted, a service worker or general user opens the door 33 of the casing and then the water discharge valve 28 to discharge the fry remnants or burned remnants deposited on the bottom of the fry vessel 10 together with the water. Then, when the interface between the oil and the water is lowered and the lower water level sensor 25 detects the interface, the upper limit-activating water level relay switch 41 is switched from the abnormal position NC1 to the normal position NO1. As a result, the red, water level warning lamp 38 for warning of an abnormal operation of the fryer is turned off. Then, the green, normal water level lamp 37 for indicating that the operation of the fryer is normal is lighted.

The heater 20 is supplied with electric power until the oil temperature sensor 21 detects that the temperature of the upper portion of the oil layer reaches the desired temperature set by a temperature set button in the operation panel 36. After the detection of the desired temperature, the electric power is supplied to maintain the oil temperature in a predetermined temperature range including the desired temperature.

Referring to FIG. 5, SSR1 and SSR2 are solid state relays for controlling the temperature of the heater, and controls the supply of the electric power to the heater 20 so that output of the temperature sensor resides in the desired temperature range set through the operation panel.

In the electrical control circuit, the outputs from the upper and lower water level sensors 24, 25 are input to terminals T2, R2. With such inputs, the upper limit-activating water level relay switch 41 is activated and the green and red lamps 37, 38 are lighted. A temperature control circuit designated by reference numeral 42 is used to control the temperature of water when the water is boiled for cleaning of the frying vessel 10.

As described above, in the table mountable fryer of which the frying vessel has the oil and the water contained at the upper and lower portions thereof, respectively, according to the present invention, any drink put into the frying vessel directly falls into the lower water due to a difference in specific gravities of the water and oil and thus explosive generation of water vapor can be prevented. Consequently, it is possible to take a meal and drink beverages while cooking fries in the frying vessel at table, and to use the fryer in a hall of a restaurant.

Since the fryer of which the frying vessel contains the oil and the water at the upper and lower portions thereof, respectively, is used in a state where it is mounted to the table, the fry remnants do not adhere to the frying vessel owing to the water existing in the lower portion. Thus, man-hour required for cleaning the fryer can be reduced to one-third times as many as that required for a conventional fryer.

Further, oxidization of the oil layer can be prohibited and deterioration of the oil layer or generation of oil fumes due to the fry remnants or burned remnants can be prevented. Moreover, even a general user who does not know discharge timing of the water depending on the amount of cooked fries can easily and safely utilize the fryer.

What is claimed is:

1. A table mountable fryer, wherein a frying vessel is installed at the center of a table and contains oil and water at upper and lower portions thereof and heating of the oil is controlled by detecting a position of an interface between the oil and the water.

2. The fryer as claimed in claim 1, comprising the frying vessel in which an oil layer is formed on a water layer due to a difference in their specific gravities; a heater installed in the middle of the frying vessel for heating the oil layer; a cooling pipe installed below the heater for cooling a portion of the oil layer below the heater; a first water level sensor installed at a predetermined position below the heater for detecting the interface between the water and oil layers; and an oil layer heating control means for stopping heating the oil layer by the heater in response to the output of the first water level sensor.

3. The fryer as claimed in claim 2, further comprising a second water level sensor installed at a predetermined position below the first water level sensor to detect the interface between the oil and water layers, wherein the oil layer heating control means includes a means for starting again heating the oil layer by the heater upon detection of the interface by the second water level sensor after the detection of the interface by the first water level sensor.

4. The fryer as claimed in claim 2, further comprising a means for issuing a warning signal indicating that the interface has been raised, when the first water level sensor detects the interface.

5. The fryer as claimed in claim 3, further comprising a means for displaying a signal indicating that a water level is at a safe position upon detection of the interface by the second water level sensor.

6. The fryer as claimed in claim 2, wherein the frying vessel is V-shaped in cross section at the lower portion thereof, one lateral side of the lower portion of the frying vessel is inclined downward, and a water discharge valve is installed at an end of the lateral side.

7. The fryer as claimed in claim 4, further comprising a means for lowering a water level by operating a water discharge valve installed at a lower end of the frying vessel upon issue of the warning signal indicating that the interface has been raised.

8. The fryer as claimed in claim 7, further comprising a means for displaying a signal indicating that the water level has been exceedingly lowered, upon detection of lowering of the interface below the second water level sensor.
